(19) United States
(12) Patent Application Publication
(10) Pub. No.: US 2002/0014317 A1
(43) Pub. Date: Feb. 7, 2002

(54) Method for processing straw pulp

(75) Inventors: Wayne H. Nay, Pleasant Hill, OR (US); William S. Fuller, Federal Way, WA (US)

Correspondence Address: PATENT DEPARTMENT CH2J29, WEYERHAEUSER COMPANY, P.O. BOX 9777, FEDERAL WAY, WA, 98063-9777, US

(73) Assignee: Weyerhaeuser Company

(21) Appl. No.: 09/938,988

(22) Filed: Aug. 24, 2001

Related U.S. Application Data
(63) Continuation of application No. 09/186,345, filed on Nov. 4, 1998.
Application No. 09/186,345 is a continuation-in-part of application No. 08/946,397, filed on Oct. 7, 1997, now Pat. No. 5,944,382.

(51) Int. Cl. D21B 1/36; B27J 1/00

(52) U.S. Cl. 162/22; 241/28

(57) ABSTRACT

A method for processing straw pulp that includes caustic treatment is provided. The caustic treated straw pulp can be incorporated into a papermaking furnish to provide a paper product. The caustic treated pulp imparts strength to papers incorporating the pulp.

### CROSS-REFERENCE TO RELATED APPLICATIONS

The present application is a continuation-in-part application of copending application Ser. No. 08/946,497, filed Oct. 7, 1997, the benefit of the priority of the filing date of which is hereby claimed under 35 U.S.C. §120.

### FIELD OF THE INVENTION

This invention relates to a method for processing straw pulp and, more particularly, to a method for processing straw pulp that includes caustic treatment.

### BACKGROUND OF THE INVENTION

There is increasing interest in the incorporation of nonwood cellulosic fibers into paper products. There is a tremendous amount of nonwood fibers available for pulp production. It has been estimated that the world straw production is approximately 500,000,000 metric tons per year. Only about half of that amount is used for low value purposes, such as building materials, fuel, and cattle feed. Most of the remaining amount is wasted by burning, without energy recovery, or plowing back into the ground. However, among the limitations in making straw into paper is incorporating the lower quality fiber derived from straw into a product with sufficient strength, durability, and brightness for a marketable end product.

U.S Pat. No. 4,040,899, issued in 1977 to Emerson, attempts to address the use of straw pulp in paper. Emerson teaches intertwining and crimping fibers into a paper web.

According to Pulp and Paper, published 1952, 1960, by Interscience Publishers, Inc.,

Straw is pulped by chemical processes and by a combination mechanical and chemical process known as mechano-chemical process. Among the different chemicals used for pulping straw are: (1) sodium hydroxide, (2) lime alone or in combination with other alkalies, (3) sodium sulfite plus other alkali, (4) chlorine, and (5) sodium hydroxide plus sodium sulfide (sulfite process). Other chemicals suggested for the pulping of straw are nitric acid and sodium chlorite. Sodium carbonate plus sulfur has been suggested for the preparation of a coarse pulp (straw Kraft) used for corrugated papers. There are four principal processes for making high grade bleachable straw pulp: (1) soda process, (2) sulfate process, (3) monosulfite process, and (4) the Pomilio chlorine process. The soda and sulfate processes produce good pulp, but in rather low yield.

### SUMMARY OF THE INVENTION

The present invention provides a method for pulping straw chips and forming a usable byproduct. According to the method, straw chips are mixed with steam and water to form a mixture. The mixture is exposed to temperatures and pressures sufficient to significantly soften the straw chips to form straw pulp, lignins, and hemicellulose when exposed to a rapid decrease in pressure. The mixture is washed to separate a portion of the lignins and hemicellulose from the straw pulp such that a usable byproduct of water, lignins and hemicellulose, referred to as black liquor, is formed and passed through a mechanical refiner.

The straw chips may be mixed with a caustic before the mixture of straw chips, steam and water is exposed to temperatures and pressures sufficient to significantly soften the straw chips to form straw pulp, lignins and hemicellulose in the mixture when exposed to a rapid decrease in pressure. The caustic may be present in the mixture in about less than two percent by weight. It is more preferred that the caustic is present in the mixture in about less than one-half percent by weight. The caustic may comprise sodium hydroxide. Also, the caustic may comprise potassium hydroxide.

In one form of the method, the mixture may be exposed to temperatures and pressures sufficient to significantly soften the mixture when exposed to a rapid decrease in pressure for between about two and one-half minutes to about eight minutes.

In yet another form of the invention, at least about seventy percent by weight of the straw chips are formed into straw pulp.

In yet another form of the invention, the pressure sufficient to significantly soften the straw chips when exposed to a rapid decrease in pressure is between about 140 psig and about 200 psig.

In another form of the invention, the fiber chips may be selected from nonwood fibers such as ryegrass, wheat and a mixture of grain and cereal straws.

Straw chips for use in the method may be formed by chopping straw to form a mixture of straw chips, meal, ash and grit and screening the mixture to separate a substantial portion of the straw chips from the meal, ash and grit. The meal, ash, and grit may be used as animal feed. In a preferred form of the invention, the meal, ash, and grit may be mixed with the black liquor byproduct to form animal feed.

The straw pulp formed by this method has a Canadian Standard Freeness between about 200 and about 600.

The present invention also provides a paper product made from wood pulp and straw pulp wherein the straw pulp is produced by mixing straw chips with steam and water to form a mixture of straw chips, steam and water. The mixture is exposed to temperatures and pressures sufficient to significantly soften the straw chips into straw pulp when exposed to decreased pressures. The mixture is then refined and a substantial portion of the straw pulp is separated from the mixture. A portion of the wood pulp and the paper product may be derived from processed post-consumer waste.

The straw chips may be formed by chopping straw to form a mixture of straw chips, meal, ash and grit and screening the mixture to separate a substantial portion of the straw chips from the meal, ash and grit.

In yet another form of the invention, the straw pulp has a Canadian Standard Freeness (CSF) of between about 200 and about 600 and an STFI between about 14 and about 21.

In another embodiment, the present invention provides a straw pulp product that, when incorporated into paper, imparts increased strength to the paper. The straw pulp product is prepared by a method that includes soaking the pulp in caustic. The method also provides meal, ash, and grit that can be used as animal feed. The meal, ash, and grit can also be mixed with the black liquor byproduct of the method to form animal feed.

These and other advantages and features will become apparent from the detailed description of the best mode for carrying out the invention that follows.

### BRIEF DESCRIPTION OF THE DRAWINGS

The foregoing aspects and many of the attendant advantages of this invention will become more readily appreciated [as the same becomes better understood] by reference to the following detailed description, when taken in conjunction with the accompanying drawings, wherein:

FIG. 1 is an elevational view of a rye grass plant;

FIG. 2 is a flow diagram of a preprocessing plant constructed according to the method of the present invention; and

FIG. 3 is a flow diagram of a pulping plant constructed according to the method of the present invention.

### DETAILED DESCRIPTION OF THE PREFERRED EMBODIMENT

The present invention provides an improved method for preprocessing and processing various lignocellulosic source materials. Suitable lignocellulosic materials include nonwood fibers such as grain and cereal straw, and corn stover. However, the methods of the present invention have been found to be particularly suited for lignocellulosic material derived from grass and straw, such as annual ryegrass, fescue, and wheat. As used herein, straw chips may refer to chips derived from any nonwood fibers such as grain and cereal straw, grass and corn stover. However, for simplicity, all such chips shall be referred to as straw chips.

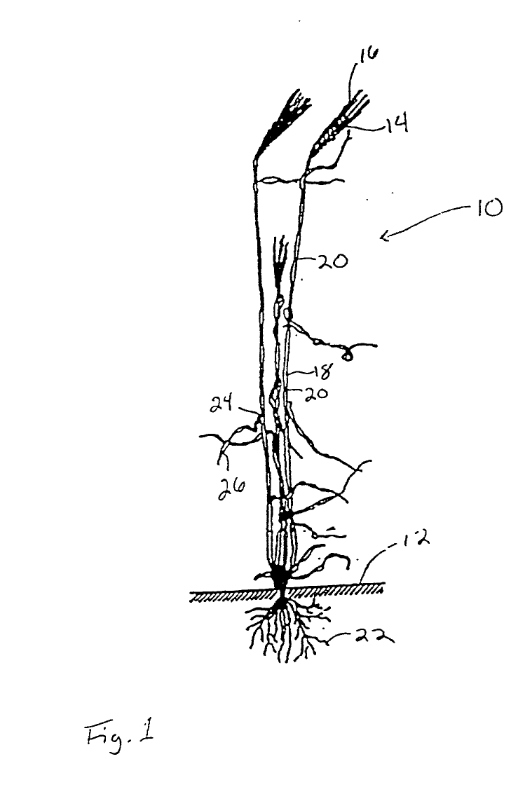

Referring first to FIG. 1, by way of example, a ryegrass plant 10 is shown growing in soil 12. The ryegrass plant 10 has seeds or kernels 14 held within ears 16, hollow stems or internodes 18 between joints or nodes 20, and an extensively branching fibrous root system 22. Sheath portions 24 are formed on the stems 18 and attach leaves 26 to the stems 18.

During harvest, the ryegrass plants 10 are cut or swathed about three to six inches from the ground, generally below the first of the joints or nodes 20. Then, the cut ryegrass plants are left to cure in the fields for a few weeks. Seeds or kernels 14 may be harvested from the cut plants by use of a combine. After the combine has removed the seeds or kernels 14, the remainder of the ryegrass plants, generally known as straw 30, is dropped to the ground. The straw 30 may be recovered from the field and baled for storage prior to further processing.

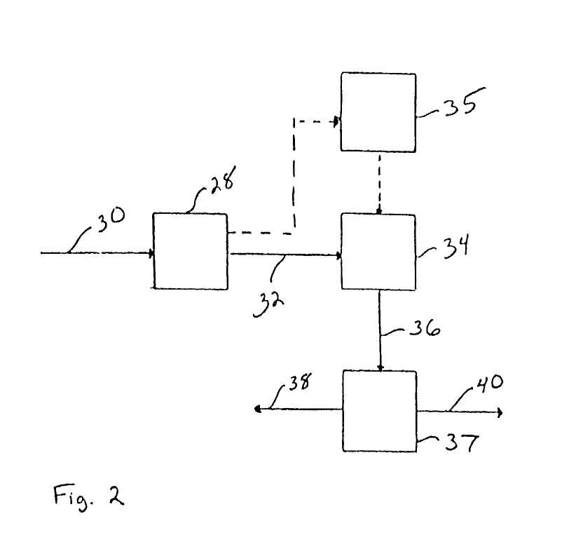

Referring to FIG. 2, for preprocessing, straw 30 is fed into a tub grinder 28. The straw 30 may be fed into the tub grinder 28 in bales. The tub grinder 28 breaks up the bales and chops the straw into pieces averaging roughly one inch in length. As the chopped straw 32 exits the mill 34, the chopped straw 32 includes nodes 20, leaves 26, sheath portion 24, and internodes 18, as well as ash, silica, and grit.

After exiting the tub grinder 28, the chopped straw 32 is sent into a mill 34 to reduce the chopped straw 32 to pieces averaging roughly one-half inches in length. The mill 34 grinds most of the nodes 20, leaves 26, and sheath portion 24 into powder.

The chopped straw 32 may be stored in a storage tank 35 before being sent to the mill 34 if the capacity of the mill 34 does not permit the chopped straw 32 to be fed directly from the tub 28 grinder to the mill 34.

After exiting the mill 34, milled mixture 36 is passed through multilayer screens 37. Meal 38 is dislodged and removed from straw chips 40 by passing the milled mixture 36 through the multilayer screens 37. The meal 38 includes nonfibrous particles and ash, enriched with silica and grit. The meal 38 may be used as an agricultural byproduct for feeding livestock.

The straw chips 40 are then ready for processing into pulp. The straw chips 40 may be stored before further processing. In addition, if the pulp processing is to be carried out at a place remote from where the straw chips 40 have been preprocessed, the straw chips 40 may be transported by any manner used to transport bulk materials, such as by the use of containers.

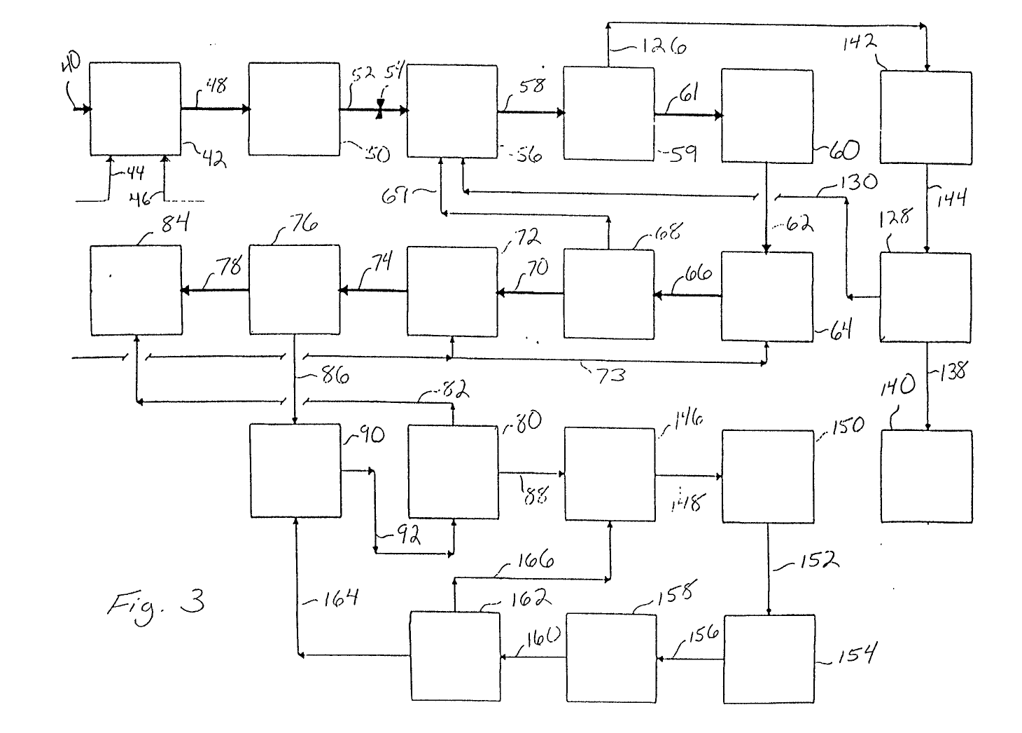

Referring to FIG. 3, for processing the straw chips 40 into pulp, the straw chips 40 are fed into a mixer 42 where they are mixed with steam and water 44 and any caustic or digestive additives 46. Typically, the amount of digestive additives 46 utilized is calculated on a weight basis per amount of dry straw chips entering the system. Scales may be incorporated into the pulping process so that the straw chips 40 may be weighed as they enter the system and the amount of digestive additives 46 may be administered at the appropriate rate.

Preferably, the amount of digestive additives 46 mixed with steam and water 44 and straw chips 40 is between about zero and about 2.0 percent by weight. However, it is more preferable that the amount of digestive additives 46 is between about zero and about 0.5 percent by weight. Suitable digestive additives 46 for use in the present invention include sodium hydroxide and potassium hydroxide.

From mixer 42, a stream 48 composed of straw chips 40, steam and water 44, and any digestive additives 46 is then fed into reactor 50. In reactor 50, stream 48 is exposed to temperatures and pressures sufficient for the steam 44 and any digestive additives 46 to penetrate the straw chips 40 such that when exposed to a rapid decrease in pressure, a mixture of softened chips, cellulose, lignins, hemicellulose and water is formed.

Suitable reactors for use in the present invention include continuous feed reactors such as those manufactured by Stake Technology, Ltd. of Oakville, Canada, and described in U.S. Pat. Nos. 4,798,651 and 4,947,743, the contents of which are incorporated herein by reference.

In the present invention, reactor products 52 may be exposed to a rapid decrease in pressure by passing the reactor products 52 into a blow tank 56. The reactor products 52 may be metered from the reactor 50 into the blow tank 56 by a blow valve 54. The reactor products 52 include softened straw pulp mixed with lignins, hemicellulose and water. In other words, straw chips are steam exploded as they pass through the blow valve 54 when exiting the reactor 50 to form straw pulp, lignins and hemicellulose.

Stream 58 from the blow tank 56 is sent into a screw press 59 where stream 126 of a straw pulp mixture is separated from the steam exploded straw chips. Stream 126 is composed substantially of black liquor and undissolved solids. Generally, stream 126 is substantially composed of water, reacted lignins and hemicellulose. Stream 126 is sent to a byproduct chest 142. Stream 144 from byproduct chest 142 is passed through filtration system 128. Solids 130 removed at filtration system 128 are sent to blow tank 56. Liquid stream 138 from filtration system 128 are collected in storage tank 140.

The black liquor collected in storage tank 140 constitutes a usable byproduct. This byproduct has usefulness as an animal feed additive. In a preferred form of the invention, the byproduct may be mixed with meal 38 from preprocessing to form animal feed. The animal feed may be formed into a mash or pellets by methods known in the art.

Stream 61 from screw press 59 is then defiberized. The defiberization may be carried out by a mechanical refiner 60, such as an Ahlstrom MDR (frotopulper).

The pulp is then ready to be washed. The pulp may be washed by any method, such as dilution and extraction. For example, the refined pulp mixture 62 may be sent to a dilution tank 64 where it is diluted with water 73. Then, diluted pulp mixture 66 from tank 64 may be thickened by use of a wash press 68. Weak black liquor in stream 69 from wash press 68 is sent to blow tank 56.

Thickened pulp 70 may then be screened to remove unwanted particles. In preparation for the screening, the thickened pulp 70 may be sent to a prescreening dilution tank 72 where it is mixed with water 73. Diluted pulp 74 from the dilution tank 72 may then be passed into a primary screening 76. Accepts 78 from the primary screening 76 may be collected in accepts tank 84.

Rejects 86 from primary screening 76 may be passed to a primary screen rejects tank 90. Rejects 92 from rejects tank 90 may be passed to a secondary screening 80. Accepts 82 from secondary screening 80 may be collected in accepts tank 84. Rejects 88 from secondary screening 80 are sent to drainer 146.

Drained stream 148 is sent to a secondary rejects tank 150. Stream 152 from secondary rejects tank 150 is sent to a rejects defiberizer 154. Stream 156 from the rejects defiberizer 154 is collected in a tertiary screen feed tank 158. Stream 160 from the tertiary screen feed tank 158 is passed through a tertiary screening 162. Accepts 164 from tertiary screening 162 are collected in the rejects tank 90. Rejects 166 from tertiary screening 162 are sent to the drainer 146.

In another embodiment, the present invention provides a straw pulp product that, when incorporated into paper, imparts increased strength to the paper. In the method, straw pulp processed as described above is further treated with caustic. Preferably, the processed straw pulp is treated by soaking in caustic. More specifically, after the thickened pulp has been diluted and screened, the resultant pulp (i.e., accepts 78 from primary screening 76) is treated with caustic. After caustic treatment, the straw pulp product can then be collected (e.g., in accept tank 84).

As noted above, meal, ash, and grit separated from the straw chips in the method can be used as animal feed. The separated meal, ash, and grit can also be mixed with the black liquor byproduct of the method to form animal feed.

The caustic for pulp soaking is preferably an aqueous solution that includes sodium hydroxide, potassium hydroxide, or mixtures of sodium hydroxide and potassium hydroxide. Suitable caustic solutions include from about 1 to about 5 percent by weight sodium hydroxide or potassium hydroxide. Preferably, the caustic contains about 2 percent by weight sodium hydroxide or potassium hydroxide. Straw pulp caustic soaking is generally carried out at ambient temperature for a period of time from about 0.5 to about 2 hour. In a preferred embodiment, straw pulp is soaked in 2 percent by weight sodium hydroxide in water solution at ambient temperature for about 0.5 hour.

Caustic treated straw pulp produced by the method of the invention can be blended with other pulps or used as the sole pulp component in a papermaking furnish to form a paper product. The caustic soak can be performed in a tank that is a storage tank supplying a furnish to a papermaking machine. The caustic treated straw pulp can be the pulp furnish supplied to a papermaking machine. Alternatively, other pulp can be added to the caustic treated straw pulp and mixed to provide a blend that can be used as a pulp furnish to a papermaking machine.

Caustic soaked straw pulp formed in accordance with the present invention increases the density and advantageously imparts strength to papers that incorporate the pulp. For example, soaking in 2% caustic increased pulp density by about 9%. Burst (lbs.) and strength as measured by STFI (Swedish Technical Forest Institute, lbs./in.) for papers prepared from caustic soaked straw pulp were determined to be greater than for papers prepared from straw pulped processed as described above that were not subjected to caustic soaking (i.e., Control in Table 1 below). Soaking in 2% caustic increased the STFI value by about 25%. An increase in the STFI value of about 9% was found for pulp soaked in caustic at about pH 9. Burst strength index increased about 9% for caustic soaked pulp, whereas smaller increases were observed at pH 9 and 10.5. No increase in burst strength index or STFI value was observed for paper incorporating straw pulp soaked at neutral pH (i.e., pH 7).

The STFI index of papers prepared from caustic soaked straw pulp approached, but did not meet, that of old corrugated containers (OCC). The STFI index for papers prepared from caustic soaked fibers was determined to be 0.48 (0.38 for paper prepared from control straw pulp) and, for paper prepared from OCC, the STFI index was determined to be 0.55. An increase in the STFI index for paper prepared from caustic soaked OCC (0.61) was also found. Thus, although caustic soaked straw pulp does not impart strength to paper to the extent that OCC does, caustic soaked straw pulp significantly improved the strength of papers that incorporated the treated pulp.

The strength of papers prepared from the various caustic soaked straw pulps is tabulated and compared to controls in Table 1 below. In Table 1, “Control” refers to straw pulp that has been processed as described above, but not subjected to caustic soaking. Table 1 also tabulates some properties of the fibers (e.g., CSF) and papers made from these fibers (e.g., basis weight and density). The papers in Table 1 are prepared from 100% of the noted pulp.

TABLE 1
Paper Strength Comparison

| | | Basis | | | | | | | STFI |
|---|---|---|---|---|---|---|---|---|---|
| | | Weight | Density | Burst | Burst | Burst | STFI | STFI | 95% Conf. |
| Pulp | CSF | lbs/ft² | lbs/ft² | lbs | Stdev | Index | lbs/in | Index | Level |
| Control (no soak) | 610 | 27.16 | 23.96 | 30 | 1.77 | 1.105 | 10.25 | 0.377 | 0.0153 |
| 2% caustic soak | 565 | 26.56 | 26.12 | 32 | 1.76 | 1.205 | 12.49 | 0.470 | 0.0140 |
| pH 7 soak | 605 | 26.52 | 23.40 | 29 | 1.41 | 1.094 | 10.01 | 0.377 | 0.0141 |
| pH 9 soak | 580 | 26.82 | 24.38 | 31 | 1.40 | 1.156 | 11.05 | 0.412 | 0.0226 |
| pH 10.5 soak | 580 | 27.08 | 24.81 | 31 | 1.57 | 1.145 | 11.50 | 0.425 | 0.0150 |
| OCC Control | 520 | 27.10 | 30.68 | 56 | 2.18 | 2.066 | 14.82 | 0.547 | 0.0091 |
| OCC 2% caustic | 520 | 27.53 | 32.07 | 65 | 2.98 | 2.361 | 16.87 | 0.613 | 0.0110 |

The nature and substance of the instant invention as well as its objects and advantages will be more clearly understood by referring to the following specific examples.

### EXAMPLE 1

Annual rye grass straw is obtained. The protein level of the straw is determined to be about three to four percent (3%-4%). The moisture content of the rye grass straw is determined to be approximately ten percent (10%). The annual rye grass straw is preprocessed and pulped according to the method described in the best mode of this application and as set forth herein.

Bales of the rye grass straw are fed into an agricultural tub grinder where the bales are broken up and the straw chopped into pieces averaging roughly one (1) inch in length. The agricultural tub grinder has grate plates with round holes sized between about one half(0.5) inches and about two (2) inches.

After exiting the agricultural tub grinder, the chopped straw is sent into a disc mill. The disc mill is a United Milling Systems mill which has milling gaps of between about 0.6 mm and about 1.0 mm. In the disc mill, the chopped straw is reduced into approximately one-half inch pieces. Also, the disc mill grinds most of the hard node, leaf and sheath of the straw into a powder. Ash and grit are determined to compose approximately two to five percent (2%-5%) of the straw fed into the tub grinder.

After leaving the milling machine, the straw is passed into a vibrating six-deck screen of 35 mesh. The screen is a gyratory screen equipped with fine mesh and ball decks for cleaning fines and dirt from the surfaces of the screen. Approximately eighteen percent (18%) of the straw mixture is removed at the screen as meal. Part of the meal removed is the powder formed in the disc mill by the hard node, leaf and sheath of the straw. The remainder of the straw chips leaving the screen averages approximately one half (½) inch in size.

The meal has a protein level of about eight to thirteen percent (8%-13%). The silica content is between about 8-15%. It is determined that the meal removed at the screen is usable as animal feed.

The preprocessed straw chips are then stored prior to pulping. The straw chips are preprocessed at a site remote from the pulping system. The preprocessed straw chips are transported to the pulping system in container trucks.

The preprocessed straw chips are fed into a pulping system at a rate consistent with the capacity of the pulping system. The preprocessed straw chips are fed into a mixer where they are mixed with steam and water to achieve a moisture content of about 40-50% based on the charge of preprocessed straw chips to the mixer. The preprocessed straw chips mixed with steam and water are fed into a Stake Digester steam explosion reactor. In the reactor, the preprocessed straw chips are exposed to pressure of about 160 psig for about five and a half (5½) minutes.

Pulp from the reactor is metered into a blow tank by a blow valve. Pulp from the blow tank is passed through a screwpress where black liquor is separated from the pulp. Then the pulp is defiberized or refined in an Ahlstrom frotopulper mechanical refiner. The refined pulp is sent to a dilution tank where it is mixed with liquid at a dilution factor of about 2.5. The diluted pulp is then thickened by use of a wash press. The thickened pulp is screened in a two-stage pressure screen with about 0.010 inch slotted plates.

It is determined that at least about seventy percent (70%) by weight of the straw chips are formed into straw pulp.

After exiting the process, the straw pulp is determined to have a Canadian Standard Freeness (CSF) of between about 200 and about 600 and STFI (Swedish Technical Forestry Institute) between about 14 and 21. As a comparison, OCC (pulp derived from recycled corrugated cardboard) is determined to have a Canadian Standard Freeness (CSF) of between about 200 and about 500 and STFI of between about 15 and about 22. Kraft pulp is determined to have a Canadian Standard Freeness (CSF) of between about 450 and about 750 and STFI of between about 21 and about 26.

Straw pulp with a Canadian Standard Freeness (CSF) between about 200 and about 600 and STFI between about 14 and about 21 is suitable to be blended with Kraft pulp and OCC to make liner board in standard mill grades. The straw pulp comprises about less than twenty percent (20%) of the liner board furnish.

### EXAMPLE 2

Example 1 is repeated using about one-half percent (0.5%) by weight sodium hydroxide in the mixer.

After exiting the process, the straw pulp is determined to have a Canadian Standard Freeness (CSF) of between about 200 and about 600 and STFI between about 14 and about 21.

### EXAMPLE 3

Example 1 is repeated using about one percent (1%) by weight sodium hydroxide in the mixer.

After exiting the process, the straw pulp is determined to have a Canadian Standard Freeness (CSF) of between about 200 and about 600 and STFI between about 14 and about 21.

### EXAMPLE 4

Example 1 is repeated using two percent (2%) by weight sodium hydroxide in the mixer.

After exiting the process, the straw pulp is determined to have a Canadian Standard Freeness (CSF) of between about 200 and about 600 and STFI between about 14 and about 21.

### EXAMPLE 5

Example 1 is repeated using about one-half percent (0.5%) by weight potassium hydroxide in place of the sodium hydroxide in the mixer.

After exiting the process, the straw pulp is determined to have a Canadian Standard Freeness (CSF) of between about 200 and about 600 and STFI between about 14 and about 21.

### EXAMPLE 6

Example 1 is repeated using about one percent (1%) by weight potassium hydroxide in place of the sodium hydroxide in the mixer.

After exiting the process, the straw pulp is determined to have a Canadian Standard Freeness (CSF) of between about 200 and about 600 and STFI between about 14 and about 21.

### EXAMPLE 7

Example 1 is repeated using about two percent (2%) by weight potassium hydroxide in place of the sodium hydroxide in the mixer.

After exiting the process, the straw pulp is determined to have a Canadian Standard Freeness (CSF) of between about 200 and about 600 and STFI between about 14 and about 21.

### EXAMPLE 8

Example 1 is repeated allowing the preprocessed straw chips mixed water to remain in the reactor for about two and one-half minutes.

After exiting the process, the straw pulp is determined to have a Canadian Standard Freeness (CSF) of between about 200 and about 600 and STFI between about 14 and about 21.

### EXAMPLE 9

Example 1 is repeated allowing the preprocessed straw chips mixed water to remain in the reactor for about 4 minutes.

After exiting the process, the straw pulp is determined to have a Canadian Standard Freeness (CSF) of between about 200 and about 600 and STFI between about 14 and about 21.

### EXAMPLE 10

Example 1 is repeated allowing the preprocessed straw chips mixed with water to remain in the reactor for about six (6) minutes.

After exiting the process, the straw pulp is determined to have a Canadian Standard Freeness (CSF) of between about 200 and about 600 and STFI between about 14 and about 21.

### EXAMPLE 11

Example 1 is repeated allowing the preprocessed straw chips mixed water to remain in the reactor for about eight (8) minutes.

After exiting the process, the straw pulp is determined to have a Canadian Standard Freeness (CSF) of between about 200 and about 600 and STFI between about 14 and about 21.

### EXAMPLE 12

Example 1 is repeated with the preprocessed straw chips mixed with water to be exposed to a pressure of about 140 psig in the reactor.

After exiting the process, the straw pulp is determined to have a Canadian Standard Freeness (CSF) of between about 200 and about 600 and STFI between about 14 and about 21.

### EXAMPLE 13

Example 1 is repeated with the preprocessed straw chips mixed with water to be exposed to a pressure of about 180 psig in the reactor.

After exiting the process, the straw pulp is determined to have a Canadian Standard Freeness (CSF) of between about 200 and about 600 and STFI between about 14 and about 21.

### EXAMPLE 14

Example 1 is repeated with the preprocessed straw chips mixed with water to be exposed to a pressure of about 200 psig in the reactor.

After exiting the process, the straw pulp is determined to have a Canadian Standard Freeness (CSF) of between about 200 and about 600 and STFI between about 14 and about 21.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for pulping straw comprising:
mixing straw chips with steam and water to form a mixture;
exposing the mixture to temperatures and pressures sufficient to significantly soften the straw chips to form straw pulp, lignins and hemicellulose when exposed to a rapid decrease in pressure;
passing the mixture through a press to separate a portion of lignins and hemicellulose from the straw pulp;
passing the straw pulp through a defiberizer to form fiberized straw pulp; and
treating the fiberized straw pulp with a caustic solution to provide caustic treated straw pulp.

2. The method of claim 1 wherein the straw chips are mixed with a caustic before the mixture of straw chips, steam and water is exposed to temperatures and pressures sufficient to significantly soften the straw chips to form straw pulp, lignins and hemicellulose in the mixture when exposed to a rapid decrease in pressure.

3. The method of claim 2 wherein the caustic is present in the mixture in about less than two percent (2%) by weight based upon the dry straw chips.

4. The method of claim 2 wherein the caustic is selected from the group consisting of sodium hydroxide, potassium hydroxide, and mixtures thereof.

5. The method of claim 1 wherein the mixture is exposed to temperatures and pressures sufficient to significantly softened the mixture when exposed to a rapid decrease in pressure for between about two and one half (2½) minutes to about eight (8) minutes.

6. The method of claim 1 wherein the straw chips are selected from the group consisting of ryegrass, wheat, a mixture of grain and cereal straws, and mixtures thereof.

7. The method of claim 1 wherein at least about seventy percent (70%) by weight of the straw chips are formed into straw pulp.

8. The method of claim 1 wherein the pressures sufficient to significantly soften the straw chips when exposed to a rapid decrease in pressure from between about 140 psig and about 200 psig to about atmospheric pressure.

9. The method of claim 1 wherein the straw chips are formed by chopping straw to form a mixture of straw chips, meal, ash and grit and screening said mixture to separate a substantial portion of the straw chips from the meal, ash and grit.

10. The method of claim 1 wherein the straw pulp has a Canadian Standard Freeness of between about 200 and about 700.

11. The method of claim 1 wherein treating the fiberized straw pulp with a caustic solution comprises soaking the pulp in a caustic solution.

12. The method of claim 1 wherein the caustic solution is an aqueous solution comprising a caustic selected from the group consisting of sodium hydroxide, potassium hydroxide and mixtures thereof.

13. The method of claim 1 wherein the caustic solution comprises a caustic present in an amount from about 1 to about 5 percent by weight of the solution.

14. The method of claim 1 wherein the caustic solution comprises a caustic present in about 2 percent by weight of the solution.

15. The method of claim 11 wherein the straw pulp is soaked in the caustic solution for a time from about 0.5 to about 2.0 hours.

16. The method of claim 11 wherein the straw pulp is soaked in a 2 percent by weight sodium hydroxide in water for about 0.5 hour.

17. The method of claim 9 wherein the separated meal, ash, and grit is used as animal feed.

18. The method of claim 1 wherein passing the mixture through a press to separate a portion of lignins and hemicellulose from the straw pulp provides a usable byproduct comprising water, reacted lignins, and hemicellulose.

19. The method of claim 18 wherein the byproduct is mixed with meal, ash, and grit to form an animal feed.

20. Animal feed comprising meal, ash, and grit separated from straw pulp according to the method of claim 9.

21. The animal feed of claim 20 further comprising the usable byproduct formed by the method of claim 18.

22. Animal feed comprising the usable byproduct formed by the method of claim 18.

23. Straw pulp produced by the method of claim 1.

24. Straw pulp produced by the method of claim 2.

25. A paper product comprising caustic treated straw pulp.

26. The paper product of claim 25 wherein the caustic treated straw pulp is formed by:
mixing straw chips with steam and water to form a mixture;
exposing the mixture to temperatures and pressures sufficient to significantly soften the straw chips to form straw pulp, lignins and hemicellulose when exposed to a rapid decrease in pressure;
passing the mixture through a press to separate a portion of lignins and hemicellulose from the straw pulp;
passing the straw pulp through a defiberizer to form fiberized straw pulp; and
treating the fiberized straw pulp with a caustic solution to provide caustic treated straw pulp.

27. A method for forming a paper product comprising forming a papermaking furnish comprising caustic treated straw pulp and forming a paper product from the papermaking furnish.

28. The method of claim 27 wherein the caustic treated straw pulp is formed by:
mixing straw chips with steam and water to form a mixture;
exposing the mixture to temperatures and pressures sufficient to significantly soften the straw chips to form straw pulp, lignins and hemicellulose when exposed to a rapid decrease in pressure;
passing the mixture through a press to separate a portion of lignins and hemicellulose from the straw pulp;
passing the straw pulp through a defiberizer to form fiberized straw pulp; and
treating the fiberized straw pulp with a caustic solution to provide caustic treated straw pulp.

29. A method for increasing the strength of a paper product comprising:
combining a papermaking furnish and caustic treated straw pulp to provide a straw pulp furnish; and
forming a paper product from the straw pulp furnish to provide a paper product having increased strength compared to a paper product formed the papermaking furnish.

30. The method of claim 29 wherein the caustic treated straw pulp is formed by:
mixing straw chips with steam and water to form a mixture;
exposing the mixture to temperatures and pressures sufficient to significantly soften the straw chips to form straw pulp, lignins and hemicellulose when exposed to a rapid decrease in pressure;
passing the mixture through a press to separate a portion of lignins and hemicellulose from the straw pulp;
passing the straw pulp through a defiberizer to form fiberized straw pulp; and
treating the fiberized straw pulp with a caustic solution to provide caustic treated straw pulp.
